(19) United States
(12) Patent Application Publication
(10) Pub. No.: US 2010/0049769 A1
(43) Pub. Date: Feb. 25, 2010

(54) System And Method For Monitoring And Managing Patent Events

(76) Inventors: Chen-Kun Chen, Changhua (TW); Ai-Lien Chang, Taoyuan (TW); Hsiao-Wen Chang, Taipei (TW); Mu-Tao Chu, Hsinchu (TW); Chao-Chin Chang, Taichung (TW); Yu-Chen Yu, Taoyuan (TW)

Correspondence Address: LIN & ASSOCIATES INTELLECTUAL PROPERTY, INC., P.O. BOX 2339, SARATOGA, CA, 95070-0339, US

(21) Appl. No.: 12/545,870

(22) Filed: Aug. 24, 2009

(30) Foreign Application Priority Data
Aug. 25, 2008 (TW) 97132373

(51) Int. Cl. G06N 5/02; G06F 17/30; G06F 3/048

(52) U.S. Cl. 707/749; 706/46; 715/771; 707/E17.033

(57) ABSTRACT

Disclosed relates to a system and a method for monitoring and managing patent events. The system comprises a patent event selection unit and a monitoring and managing patent unit. The patent event selection unit verifies any combination of the time, prosecution status, qualification and contents of a patent event according to the inputted information related to the patent event. The unit also monitors and analyzes the patent event. The monitoring and managing patent unit sets up alert and/or warning activated, generates corresponding responses or provides related comments or actions.

### TECHNICAL FIELD

The disclosure generally relates to a system and method for monitoring and managing patent events, and more specifically to a patent monitoring and warning system and method for accelerating validation of patent analysis and/or US patent enforceability.

### BACKGROUND

Patent application process includes the following of patent regulations and legal verdict outcomes. There are many possible events during the patent application process that could render the application invalid or be used as evidence as unenforceability of a patent; for example, an application makes a slip in the application process, adds or deletes patent claims without corresponding actions, for information material to patentability generated during the process, such as, corresponding counterpart foreign application, domestic continuing application of the original application, and related domestic co-pending application, and so on, that should be filed, and yet failed to, to the authority. When filed against a third-party in a patent infringement law-suit, all the above defects may be used as evidence by the accused for the argument to render the patent invalid or unenforceable.

Therefore, a configurable process control or analysis can, not only ensure every step of the application process follows the regulation, but also save the manpower as well as operation cost. When facing a patent lawsuit or lawsuit threat, the configurable process control and analysis or other specific designed display may also be used to analyze the changes of claims, the final scope of the claims or abandoned claims of the target patent or patent groups to further analyze whether there exists possibility of invalidation or unenforceability as the patent strategy to save the legal action cost and improve efficiency.

### SUMMARY

The disclosed exemplary embodiments of the present invention may provide an intelligent system and method for monitoring and managing patent events.

In an exemplary embodiment, the disclosed relates to an intelligent system for monitoring and managing patent events. The system comprises a patent event selection unit and a monitoring and managing patent unit. The patent event selection unit verifies any combination of the time, prosecution status, qualification and contents of a patent event according to the inputted information related to the patent event. The unit also monitors and analyzes the patent event. The monitoring and managing patent unit sets up alert and/or warning activated, generates corresponding responses or provides related comments or actions.

In another exemplary embodiment, the disclosed relates to an intelligent system for monitoring and managing patent events. The system comprises a patent event selection unit and a monitoring patent unit. The patent event selection unit is to receive information of at least a patent document. The information of at least a patent document includes any combination of time, prosecution status, qualification and contents of patent document. The patent event selection unit detects the information of at least a patent document in accordance with at least a determination rule to generate a detection signal. The detection signal includes any combination of a time detection signal, a qualification detection signal, a content detection signal and a figure detection signal. The time detection signal, the qualification detection signal, the content detection signal and the figure detection signal are to represent respectively a time relevance, a qualification relevance, a content relevance and a figure relevance of the at least a document in terms of time, qualification, content and figure. The monitoring and managing patent unit is to set up the triggering condition according to the detection signal, and when the triggering condition is met and the system is triggered, a state signal corresponding to the at least a document is generated.

In another exemplary embodiment, the disclosed relates to an intelligent method for monitoring and managing patents. The method comprises: based on an inputted information of a patent (either a single or a plurality of patent numbers), determining any combination of the time, prosecution status, qualification and content of the patent; designing the process control rules for patents as a plurality of logic rules to perform monitoring and analyzing the patent; and based on the result of monitoring and analysis, setting triggering conditions and corresponding state, and generating corresponding warning response or providing related suggestion or response.

Yet in another exemplary embodiment, the disclosed relates to an intelligent method for monitoring and managing patents. The method is applicable to an information processing device, and displays the patent analysis result in a graphic manner. The method comprises: receiving at least a patent document and corresponding information of the patent document via a communication media, where the information including any combination of corresponding time, prosecution status, qualification and content of the patent document; detecting the information in accordance with at least a determination rule to generate a detection signal; and according to the detection signal to set a triggering condition, and when the triggering condition being met and the system being triggered, generating a state signal corresponding to the at least a patent document.

Yet in another exemplary embodiment, the disclosed relates to an intelligent method for monitoring and managing patents. The method is applicable to an information processing device. The method comprises: receiving a first patent document and related information of the first patent document, where the related information including any combination of the corresponding time, prosecution status, qualification and content of the first patent document; detecting the related information in accordance with at least a determination rule to generate a detection signal; analyzing the information in accordance with the at least a determination rule to generate an attribute information corresponding to the first patent document, the attribute information including any combination of an element attribute information, a link attribute information, a function attribute information, an accompanied result information, a step attribute information, a scope attribute information and an others attribute information; setting a trigger condition according to the detection signal and when the triggering condition being triggered, generating a state signal corresponding to the first patent document; and listing any combination of the attribute information and the state signal in a form.

In another exemplary embodiment, the disclosed relates to a computer program product applicable to hardware, and the computer program product may be program code stored in a storage medium, such as, memory. By executing the program code on the hardware, an intelligent method for monitoring and managing patents of the present invention may be realized. The hardware may be, but not limited to, a computer, a device able to execute multiple threads, a device able to execute a single thread.

In another exemplary embodiment, a user may use Internet-enabled devices, such as, computer, mobile phone or PDA, to login to a server. The server is installed with the system and/or software of the exemplary embodiment, and the user may execute directly the operation of the intelligent method for monitoring and managing patents of the exemplary embodiment on the server. Alternatively, the user may use internet-enabled devices, such as, computer, mobile phone or PDA, to login to a server. Through the server and the database system installed with the system and/or method of the exemplary embodiment to execute the operations of the intelligent method for monitoring and managing patents disclosed in the exemplary embodiment.

Yet in another exemplary embodiment, the disclosed relates to a method of identifying relevant patents for information processing device. The method comprises: extracting a first data of a first patent document; extracting a second data of a second patent document; and when the first data and the second data satisfying a pre-defined condition of the information processing device, marking the first patent document and the second patent document as relevant patents.

In another exemplary embodiment, the disclosed relates to a method of identifying relevant patents for information processing device. The method comprises: comparing a first data corresponding to a first patent document to a second data corresponding to a second patent document; and when the comparison result matching a pre-defined condition of the information processing device, marking the first patent document and the second patent document as relevant patents.

Yet in another exemplary embodiment, the disclosed relates to a method of identifying relevant patents for information processing device. The method comprises: extracting at least a first characteristic data of a first patent document; extracting at least a second characteristic data of a second patent document; and comparing the first characteristic data and the second characteristic data to generate a corresponding relevance.

Yet in another exemplary embodiment, the disclosed relates to a method of displaying relevant attributes of a patent document for information processing device. The method comprises: establishing an actual graphical interface in a two-dimensional array; marking a version of a target claim of a patent document and displaying in the first dimension of the graphical interface; and listing and displaying the content of status of at least an attribute information of the target claim in each version in the second dimension of the graphical interface.

Yet in another exemplary embodiment, the disclosed relates to a method of displaying relevant attributes of a patent document for information processing device. The method comprises: establishing an actual graphical interface in a two-dimensional array; marking the status or content of an attribute information of a target claim of a patent document in each historical version of the target claim, and displaying in the first dimension of the graphical interface; and listing and displaying a plurality of attribute information of the target claim in a target version in the second dimension of the graphical interface.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows an exemplary schematic view of an intelligent system for monitoring and managing patent events, consistent with certain disclosed exemplary embodiments.

FIG. 2 shows an exemplary schematic view of an embodiment of the modules of the patent event selection unit and monitoring and managing patent unit, consistent with certain disclosed exemplary embodiments.

FIG. 3 shows an exemplary logic form and actual application by using the qualification validation module as an example, consistent with certain disclosed exemplary embodiments.

FIG. 4 shows an exemplary a logic form and actual application by using content validation module as an example, consistent with certain disclosed exemplary embodiments.

FIG. 5 shows an exemplary flowchart of applying qualification validation module and content validation module in the control of filing an information disclosure statement, consistent with certain disclosed exemplary embodiments.

FIG. 6 shows an exemplary response provided by a logic form of the suggested course of actions by using the control of filing an information disclosure statement as an example, consistent with certain disclosed exemplary embodiments.

FIG. 7 shows an exemplary flowchart of using qualification validation module, content validation module and suggested course of action to monitor and control the filing of an information disclosure statement, consistent with certain disclosed exemplary embodiments.

FIG. 8 shows another exemplary flowchart of using qualification validation module, content validation module and suggested course of action to monitor and control the filing of an information disclosure statement, consistent with certain disclosed exemplary embodiments.

FIG. 9 shows an exemplary flowchart of using patent event selection unit and monitoring and managing patent unit to control the process of adding and deleting inventors, consistent with certain disclosed exemplary embodiments.

FIG. 10 shows an exemplary form obtained by the analysis result of the content validation module, consistent with certain disclosed exemplary embodiments.

FIG. 11 shows another exemplary form obtained by the analysis result of the content validation module, consistent with certain disclosed exemplary embodiments.

FIG. 12 shows an exemplary schematic view of an intelligent method for monitoring and managing patent events, consistent with certain disclosed exemplary embodiments.

FIG. 13 shows another exemplary schematic view of an intelligent method for monitoring and managing patent events, which is applied to an information processing device and displays the patent analysis result in a graphic manner, consistent with certain disclosed exemplary embodiments.

FIG. 14 shows another exemplary schematic view of an intelligent method for monitoring and managing patent events, applicable to an information processing device, consistent with certain disclosed exemplary embodiments.

### DETAILED DESCRIPTION OF THE EXEMPLARY EMBODIMENTS

According to the present invention, the disclosed intelligent system for monitoring and managing patents may monitor and analyze the patent documents according to the time, prosecution status, qualification and contents of the patent documents. Through the monitoring and analysis results, the trigger conditions and corresponding status are set, and suggestions for handling are provided to the user or managers.

Before monitoring and analyzing the patent documents, the patent documents can be dissected into raw patent data, including application dates, publication dates, issue dates, priority dates, priority numbers, abstracts, figures, claims, summaries, description, classification numbers, assignees, inventors, examiners, and so on, and imported into the system. The system may translate the raw data and assign, based on the categories, to each corresponding module to process. The corresponding modules may be, for example, qualification validation module, time validation module, content validation module, figure validation module and interactive matching validation module.

Time validation module is to verify and/or extract the information related to time and date of at least a patent document, including, but not limited to, application document, description document, claims, and examination history. The information related to time and date includes application date, key date, dates of notice of rejection, issue date, dates of notice of allowance, fee payment date, issue date, and so on. In an embodiment, the time validation module may use, after verifying and/or extracting the time related parts of each patent document and comparing corresponding information of each patent document, a time detection signal to represent the result of the verification and/or extraction, or further performs relevance comparison and weight assignment, for example, 5 points for the same application date, 4 points for less than a week apart, 3 points for less than a month apart, and so on, to further obtain relevance between the patent documents, also called time relevance.

Qualification validation module may validate the background information of one or more patent documents, including, but not limited to, inventors, assignees, continuation announcement, priority announcement, number of claims or prosecution status, and may further include the status of the same or similar claims in a plurality of patent documents being modified or deleted. For example, the qualification validation module may validate the patent documents whether including at least one same inventor or assignee, whether having a continuation relationship, whether a patent document being in the status of issued, abandoned, non-provisional application, whether having the same or similar claims (through the extractions of the claims of a plurality of issued or published patent documents or prosecution history to compare the claim contents appearing in the issued/published patent documents or prosecution history, the similarity may be defined as the difference within certain number of words.), checking whether these claims being cancelled or withdrawn. In other exemplary embodiments, the qualification validation module can also check whether the number of claims in patent documents exceeds a certain threshold.

In an exemplary embodiment, after validating the background information of the patent documents, the qualification validation module may further perform relevance comparison and weight assignment. For example, by performing comparison of the inventor and assignee of the patents, and a different weight is given based on the similarity of the comparison result. For instance, if one patent document has two inventors and the other patent document has three inventors. If the two patent documents have two same inventors, a similarity of 5 points is assigned. If the two patent documents have one same inventor, a similarity of 3 points is assigned. If the two patent documents have no same inventor, a similarity of 0 point is assigned. Hence, according to different points assigned, a qualification detection signal is used to represent the validation result, and the relevance, also called qualification relevance, of the patent documents may be known.

The content validation module may validate, extract, analyze or verify the content information of the patent documents, including, but not limited to, application document content, description document content, figures, claims and/or prosecution history. For example, the content validation module can determine whether the content information of the patent documents belong to the prior art cited information of the foreign and domestic application of the same priority, prior art cited information of the lawsuit case, prior art cited information of co-pending, prior art cited information of cases with the same or similar subject matters, prior art cited information used for questioning the patentability of the patent, the addition or the deletion of the claims of a single patent document or among a plurality of patent documents, the decomposition of the claim attributes, the remarks and analysis of the changes of the claims, and so on. In an exemplary embodiment, the content validation module may use, after validating, extracting, analyzing or verifying the content information of the patent documents, a content detection signal to represent the result obtained by validation, extraction, analysis and verification.

The aforementioned claim attributes may include any combination of an element attribute information, a link attribute information, a function attribute information, an accompanied result attribute information, a step attribute information, a scope attribute information and an others attribute information, for example, the decomposition of claims—preamble, element, dependency relation, subordinate relation, function, composition, ingredient ration, predicable result, specific operating scope, step or method. Through term comparison, artificial intelligence technology in combination with a lookup form, the content validation module may perform attribute decomposition and/or analysis on the content of the claim, and output a content detection signal.

The figure validation module may analyze a plurality of patent documents to find whether the patent documents include the same or similar figures. Through figure recognition technology in combination with artificial intelligence technology, the figure validation module may verify the similarity and assign a weight according to the similarity, and then output a figure detection signal.

After analyzing the content or the figures of the patent document respectively, the content validation module and the figure validation module may use a content detection signal or a figure detection signal to include the aforementioned analysis result output. Furthermore, the content validation module and the figure validation module may compare the similarity of the content or the figures of patent documents, assign weight to know the relevance among the patent documents, and use a content detection signal or a figure detection signal for output.

When the content validation module verifying the similarity among the patent documents, the content validation module may assume that the patent documents having the same cited references of prior arts have a certain similarity. Alternatively, the similarity may also be validated by using relevant vocabulary bank comparison, lookup form, semantic analysis and artificial intelligence technology to analyze the same or similar abstract, same classification code, same or similar summary, same or similar embodiment description or claims.

The relevance between different modules may be also compared by the interactive matching validation module. The relevant information may be, such as, information of time validation module vs. qualification validation module, or information of qualification validation module vs. content validation module. For example, the time detection signal extracted by the time validation module must be validated in combination with the qualification detection signal of qualification validation module to depict the basis of the priority claim. In other words, the cross-reference and validation between the output signals from the aforementioned modules belong within the scope of the interactive matching validation module.

After computing the points of each module, different weights may also be assigned again to obtain a total score, by manual adjustment of weight if necessary, to determine the relevance information between the patent documents.

According to the result generated from the patent documents, the triggering conditions and corresponding state may be set in advance to generate corresponding warning response or provide related suggestions for handling. The pre-set triggering conditions and corresponding states may be designed, such as, into a plurality of logic forms, or embedded into the modules of the system. Based on the logic forms, the system may provide suggestions or related warning messages to the user or the administrator.

Accordingly, the output information, such as weight, generated by the disclosed embodiments performing extraction of patent documents and subsequent processing on patent documents is not merely a simple re-arrangement of the data or simple information disclosure. Instead, the output information is a function data. In other words, the data, such as, patent documents, are read by a data processing device, such as a PC, PDA or mobile phone, implementing the present invention, and the data processing device processes the data in a functional manner, such as, decomposing the patent documents and assigning to corresponding module for further processing according to the type and the definition. Each module then validates or extracts the related parts from the patent documents, such as, time validation module validating or extracting the application date, key dates, notice of rejection issue date, notice of allowance issue date, expense pay date, issue date, and so on, and qualification validation module validating the inventor, assignee, application status, claim status, and so on. Then, each module performs relevance comparison, such as, comparing the inventors or assignees of the two patent documents. Finally, the processed information from the present invention, such as, weight, warning response, suggestion to user or administrator for handling, and so on, may assist the user to fully understand the relevance of the searched patent documents and how to handle the functional effectiveness. The disclosed embodiments may provide a technological data processing program using a data processing device to process an external technological data, and accomplish a series of technological processing on the technological data.

Accordingly, the following exemplary embodiments describe the structure of an intelligent system for monitoring and managing patent events.

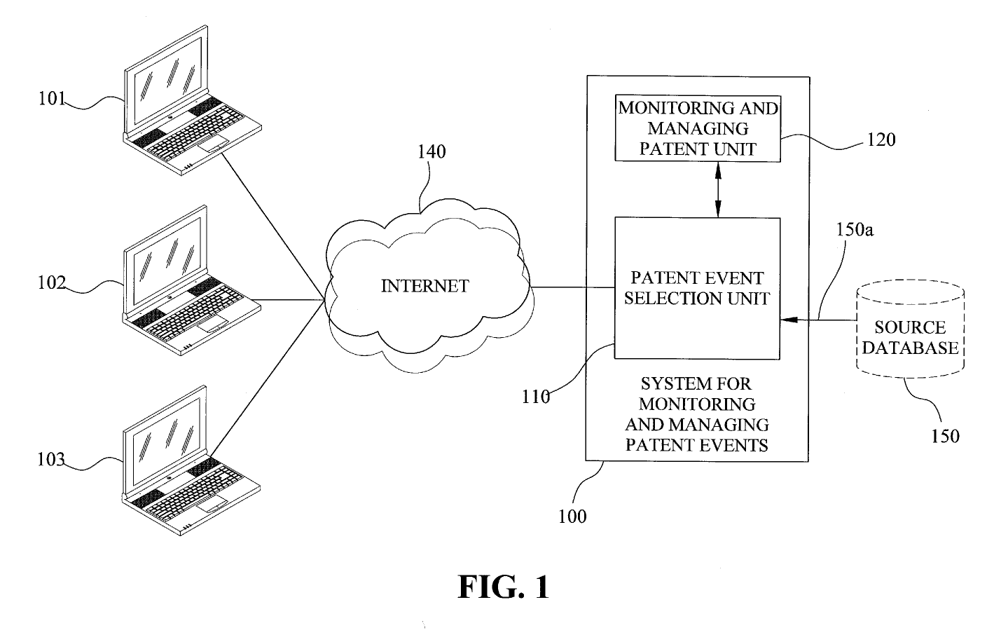

FIG. 1 shows an exemplary schematic view of an intelligent system for monitoring and managing patent events, consistent with certain disclosed exemplary embodiments. As shown in FIG. 1, a plurality of clients 101, 102, 103 utilize an intelligent system for monitoring and managing patent events 100 via connection, such as Internet 140, to perform systematically monitoring and analyzing a patent information 150a of at least a source database 150, to set the triggering-conditions and corresponding states so as to effectively reflect the patent event and corresponding mechanism The source database may be an external database or internal database to intelligent system for monitoring and managing patent events 100.

As shown in FIG. 1, intelligent system for monitoring and managing patent events 100 may comprise a patent event selection unit 110 and a monitoring and managing patent unit 120. According to an inputted patent information, such as a patent document from at least a source database 150, patent event selection unit 110 determines any combination of the time, prosecution status, qualification, contents, and figures, and performs the monitoring, comparison an/or analysis on the patent.

In an exemplary embodiment, patent event selection unit 110 may generate at least a detection signal after receiving and evaluating the information of an inputted patent, for depicting the status, including but not limited to time, content, qualification, figures or relevance, weight, and so on, of the inputted patent information. In another exemplary embodiment, patent event selection unit 110 may generate a time detection signal, a qualification detection signal, a content detection signal and a figure detection signal respectively after receiving and evaluating the information of an inputted patent, for depicting the time status, qualification status, content status, figure status, and/or the assigned weight based on the relevance of a plurality of patent document in the above statuses.

Based on the monitoring and analysis result, monitoring and managing patent unit 120 sets the triggering conditions and corresponding states, and generates corresponding warning response or provides suggestions for handling. In other words, patent event selection unit 110 may be seen as a logic mechanism to determine any combination of the qualification, prosecution status, time, patent content. The determined result may be used as a basis for subsequent systematic process control. Monitoring and managing patent unit 120 may be seen as a monitoring feedback mechanism, for effectively reflecting the patent event and corresponding response. In an exemplary embodiment, patent event selection unit 110 and monitoring and managing patent unit 120 may be implemented in either hardware or software.

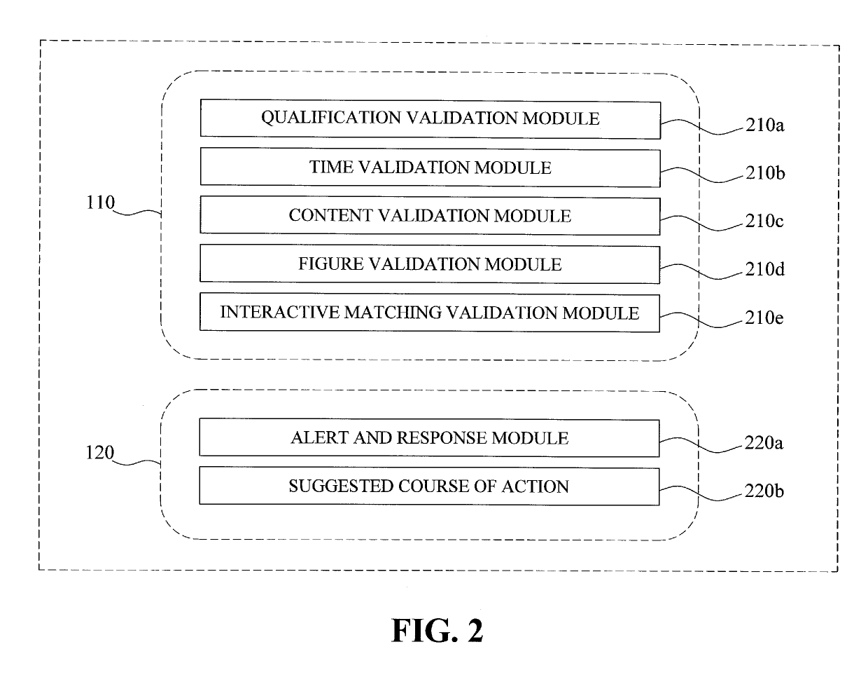

As shown in FIG. 2, patent event selection unit 110 may further include any combination of a qualification validation module 210a, a time validation module 210b, a content validation module 210c, a figure validation module 210d and an interactive matching validation module 210e. Before performing any patent monitoring and analysis, patent event selection unit 110 may decompose the patent and assign to qualification validation module 210a, time validation module 210b, content validation module 210c, figure validation module 210d and interactive matching validation module 210e according to the type and definition for processing. In other words, qualification validation module 210a, time validation module 210b, content validation module 210c, figure validation module 210d and interactive matching validation module 210e receive related information respectively, and generate corresponding detection signals.

For example, time validation module 210b receives, decomposes and analyzes the patent, extracts the time attribute information, and finally generates a time detection signal. Similarly, qualification validation module 210a receives, decomposes and analyzes the patent, extracts the qualification attributed information, and finally generates a qualification detection signal. Content validation module 210c and figure validation module 210d generate content detection signal and figure detection signal, respectively. Monitoring and managing patent unit 120 further includes an alert and response module 220a and a suggested course of action 220b.

According to the signals from each module in patent event selection unit 110, when the pre-set triggering conditions are triggered, monitoring and managing patent unit 120 may also send the corresponding action instruction to alert and response module 220a to generate a corresponding warning message to remind the user. Alternatively, the corresponding action instruction may be sent to suggested course of action 220b to generate corresponding suggestion for handling for the user's reference. In an exemplary embodiment, qualification validation module 210a, time validation module 210b, content validation module 210c, figure validation module 210d and interactive matching validation module 210e may be either realized with hardware or software. Similarly, alert an response module 220a and suggested course of action 220b may also be realized with wither hardware or software.

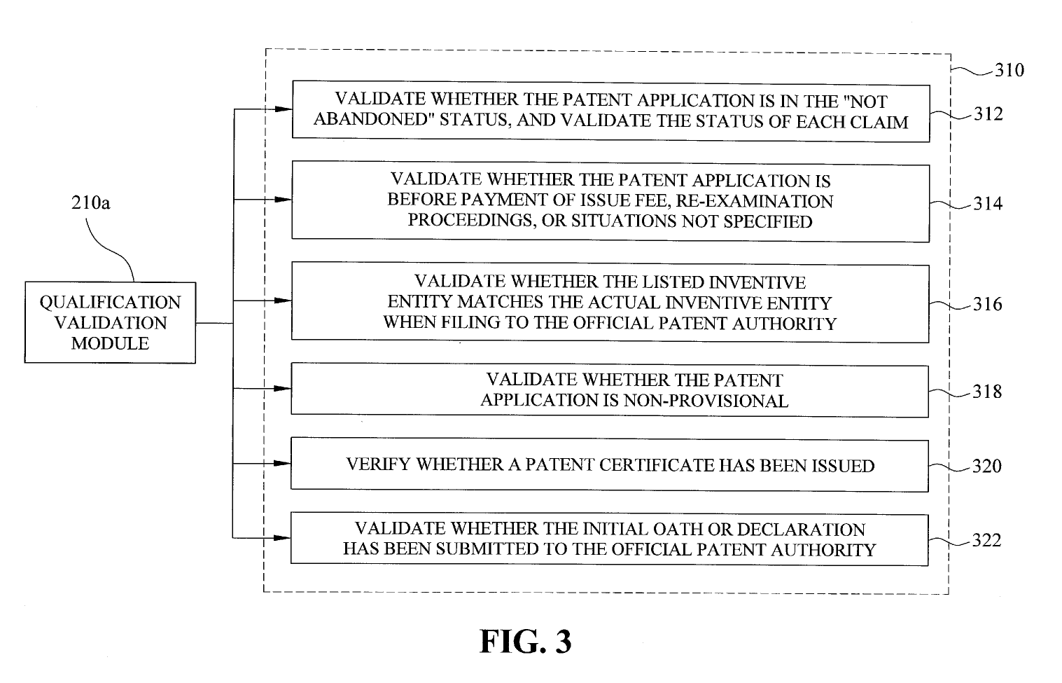

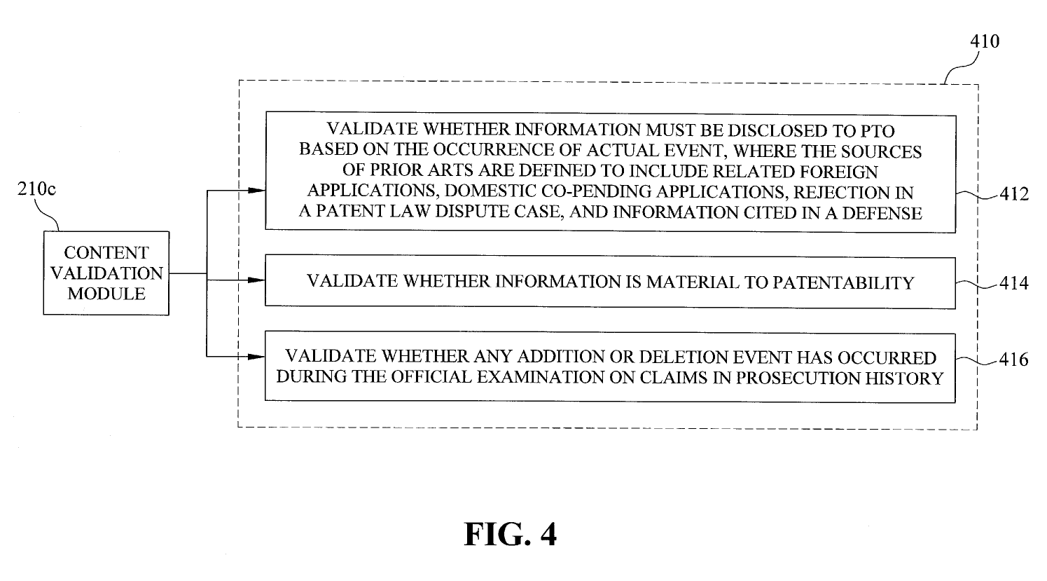

Each module of patent event selection unit 110 may use a logic form to validate the prosecution status of the corresponding pending application of the patent. FIG. 3 and FIG. 4 show exemplary logic forms for qualification validation module 210a and content validation module 210c respectively, consistent with certain disclosed exemplary embodiments.

Referring to FIG. 3, qualification validation module 210a may use a logic form 310 to validate the prosecution status of the corresponding pending application of the patent. Logic form 310 may be applied to validating whether various patent events have occurred. Logic form 310 may include one or more elements, such as, any combination of elements 312, 314, 316, 318,320, 322. These elements may be designed as the logic predicate of qualification validation. The logic predicate must ensure that the steps of patent application process follow the regulations.

For example, element 312 of logic form 310 may be applied to the patent event of duty to disclosure. Element 312 may also be designed as a logic predicate for qualification validation. The logic predicate must ensure all the steps of the application process follow the regulations. Therefore, element 312 may also be designed as the validation of whether the patent application is in the “Not Abandoned” status, and the validation of status of each claim. The former validation takes the overall patent application into account, while the latter validation focuses on the status of each individual claim. The logic predicate of element 312 may be designed as: only when the patent application is in the “Not Abandoned” status, and each claim is both “Not Withdrawn” and “Not Cancelled”, logic predicate of element 312 will pass the validation.

Similarly, element 314 of logic form 310 may be applied to a different type of specific patent event, such as, before payment of issue fee, re-examination proceedings, or situations not specified. Similarly, element 314 may also be designed as a logic predicate for validating whether a specific patent event has occurred.

Accordingly, elements 316, 318, 320, 322 of logic form 310 can all validate if different types of patent events have occurred. For example, element 316 may validate whether the listed inventive entity matches the actual inventive entity when filing to the official patent authority, referred to as PTO for the remaining of the disclosure. For instance, if the inventive entity includes A, B and D when filing to PTO, and the actual contributors to the patent claims are A, B and C, then the logic predicate of element 316 may validate the important fact that the inventive entity is not identical to the actual contributors of the patent claims.

In addition, for example, element 318 may validate a specific patent event, i.e. whether a patent application is anon-provisional application. Take US Patent Law as example, the application may be categorized as provisional application or non-provisional application depending on whether claims are included in the original patent application document. In other words, provisional applications only require description of the invention and figures to obtain an application date and an application number. The claims are non-essential for the provisional applications. On the other hand, non-provisional application requires at least a claim in the original application document to obtain the application date and application number. Therefore, element 318 may validate whether the U.S. application Ser. No. is prefixed with 60, 61, 62 . . . to determine whether the patent application in question is provisional application or non-provisional application.

Element 320 may validate a specific patent event, such as, whether a patent certificate has been issued. Element 322 may validate, such as, whether an initial oath or declaration is submitted to PTO.

Referring to FIG. 4, content validation module 210c may also use another exemplary logic form 410 for validating the prosecution status of the pending application and be applied to validate whether various types of specific patent events have occurred. Logic form 410 may, such as, include any combination of elements 412, 414, 416.

For example, elements 412, 414 of logic form 410 may be used in combination to monitor the patent event of duty to file the information disclosure statement of prior arts. Element 412 may be designed to validate whether information must be disclosed to PTO based on the occurrence of actual event, where the sources of prior arts are defined to include related foreign applications, domestic co-pending applications, rejection in a patent law dispute case, and information cited in a defense. For instance, in the related foreign application and domestic co-pending application, the reason for rejection and technology cited in office action (OA) received from PTO during the prosecution process are used as sources. Also, the defense cited by a patent in a law dispute case on invalid, unenforceable and inequitable conduct and the aforementioned defense evidence are also sources. The generation of the above reasons, prior arts or evidence of defense all defines the occurrence of patent events.

Hence, after inputting all the information into the system, as long as the new information is non-cumulative to the recorded information in the file history of the patent application, that is, the reason of rejection in OA, prior arts, evidence incurred by same fact have never been filed to PTO and not recorded in the file history of the patent application, the logic predicate of element 412 must determine that the information should be filed or disclosed to the PTO.

The information source event validated by element 414 of logic form 410 is not restricted, and can be the same as the information source event of element 412, or different from the information source event, such as, from the exhibition or trade show that the filing obligor learns to be related with the patent application. Therefore, element 414 emphasizes the validation of the information content. During the prosecution history, the applicant may claim patentability of the application or dispute the OA of rejection of the examiners. Any information opposed to the above two positions may be used by the examiners during the examination of the patent application, and as grounds for allowance or rejection. At this point, the information opposed to the aforementioned positions is the information material to patentability. Element 414 may be designed to validate whether the information is material to patentability. Once the information is material to patentability, the content validation result from the logic predicate of element 414 is that the information must be filed to the PTO.

Element 416 of logic form 410 may be designed to validate whether any addition or deletion event has occurred during the official examination on claims in prosecution history. If so, the content of validated result from logic predicate of element 416 is to pass.

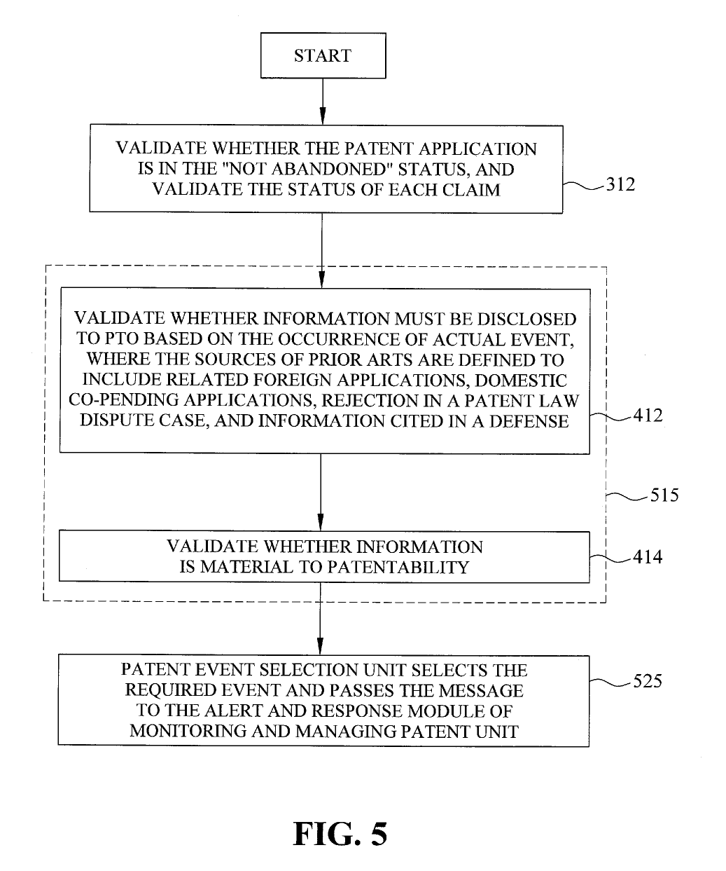

The result of whether any specific patent event validated by the elements of aforementioned qualification validation module 210a and content validation module 210c has occurred will affect the suggested course of action provided by suggested course of action 220b. FIG. 5-FIG. 7 use the monitoring on filing an information disclosure statement as an example for explanation, consistent with certain disclosed exemplary embodiments.

Up to this point, the above embodiments conform to the aforementioned “reading data into a data processing device implementing the present invention, and executing a function processes via the data processing device to generate functional data that may help the users” or “using a computer to execute a data processing program to process an external technical data and accomplish a series of technical processing on the technical data”.

For example, content validation module 210c of FIG. 4 may use a logic form 410 to validate patent event status corresponding to different specific patent events. Because element 414 of logic form 410 may validated whether the information is material to the patentability, the comparison, analysis and summary technologies must all be included for implementation. Hence, logic form 410 is already itself a technical feature, where the detailed implementation is described earlier and is omitted here. In addition, the data generated from the above technical means may provide the user a correct and timely response and suggestion through monitoring and managing patent unit 120, and provide a more user-friendly and convenient user interface.

FIG. 5 shows an exemplary flowchart of applying qualification validation module and content validation module in the control of filing an information disclosure statement, consistent with certain disclosed exemplary embodiments. As aforementioned, qualification validation module 210a may use element 312 of logic form 310 to validate whether a pending application is in “Not Abandoned” status and validate the status of each claim. After passing the qualification validation, content validation module 210c may employs the actual event that has occurred and use elements 412, 414 of logic form 410 to validate whether the information disclosure statement must be filed with PTO or the information is material to patentability, as shown in step 515. The logic predicates of elements 412, 414 of logic form 410 are as described earlier.

After validation of content validation module 210c, patent event selection unit 110 selects the required patent events and sends the message to alert and response module 220a of monitoring and managing patent unit 120, to enable alert and response module 220a to issue a status output, such as warning, to control the filing of the information disclosure statement, as shown in step 525.

To differentiate different types of warnings so as to trigger suggested course of action 220b to react differently, element 314 of logic form 310 of qualification validation module 210a may be used to validate whether a specific event has occurred. Take US Patent Law as example. The patent applications verified to require filing information disclosure statements are categorized as before payment of issue fee, re-examination proceeding, and after payment of issue fee without re-examination proceeding statuses, respectively. Therefore, suggested course of action 220b may use a logic form to provide different responses.

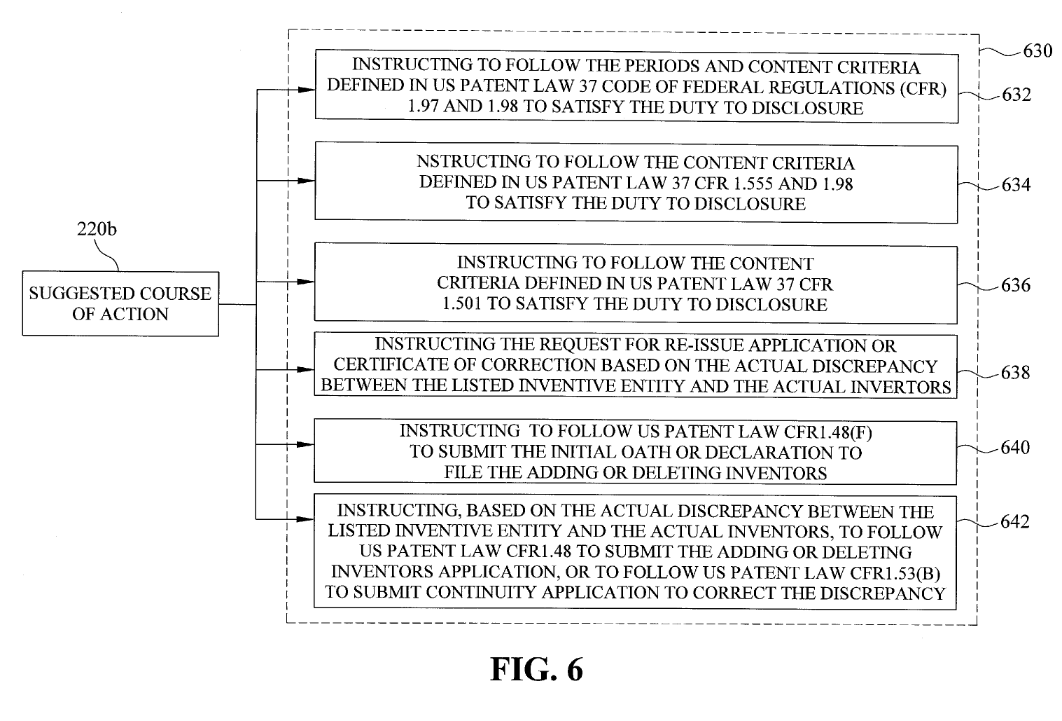

FIG. 6 shows an exemplary response provided by a logic form of the suggested course of actions by using the control of filing an information disclosure statement as an example, consistent with certain disclosed exemplary embodiments. Referring to FIG. 6, suggested course of action 220b may use a logic form 630 to provide responses. For example, logic form 630 may include any combination of elements 632, 634, 636, 638, 640 and 642. Because after the validation by element 314 of logic form 310, the patent applications verified to require to file information disclosure statements are categorized as before payment of issue fee, re-examination proceeding, and after payment of issue fee without re-examination proceeding, the three statuses may be mapped to responses provided by elements 632, 634, 636 of logic form 630 of suggested course of action 220b, respectively.

Therefore, for the patent application in before payment of issue fee status, response provided by element 632 is: instructing to follow the periods and content criteria defined in US Patent Law 37 Code of Federal Regulations (CFR) 1.97 and 1.98 to satisfy the duty to disclosure. For the patent application in the re-examination proceedings status, the response provided by element 634 is: instructing to follow the content criteria defined in US Patent Law 37 CFR 1.555 and 1.98 to satisfy the duty to disclosure. In other words, the periods are different from the periods defined in 1.97 for patent applications; instead, the periods are defined according to specific disclosure in the 1.555 re-examination proceeding to satisfy the duty to disclosure. For patent application in the after payment of issue fee without re-examination proceedings, the response provided by element 636 is: instructing to follow the content criteria defined in US Patent Law 37 CFR 1.501 to satisfy the duty to disclosure.

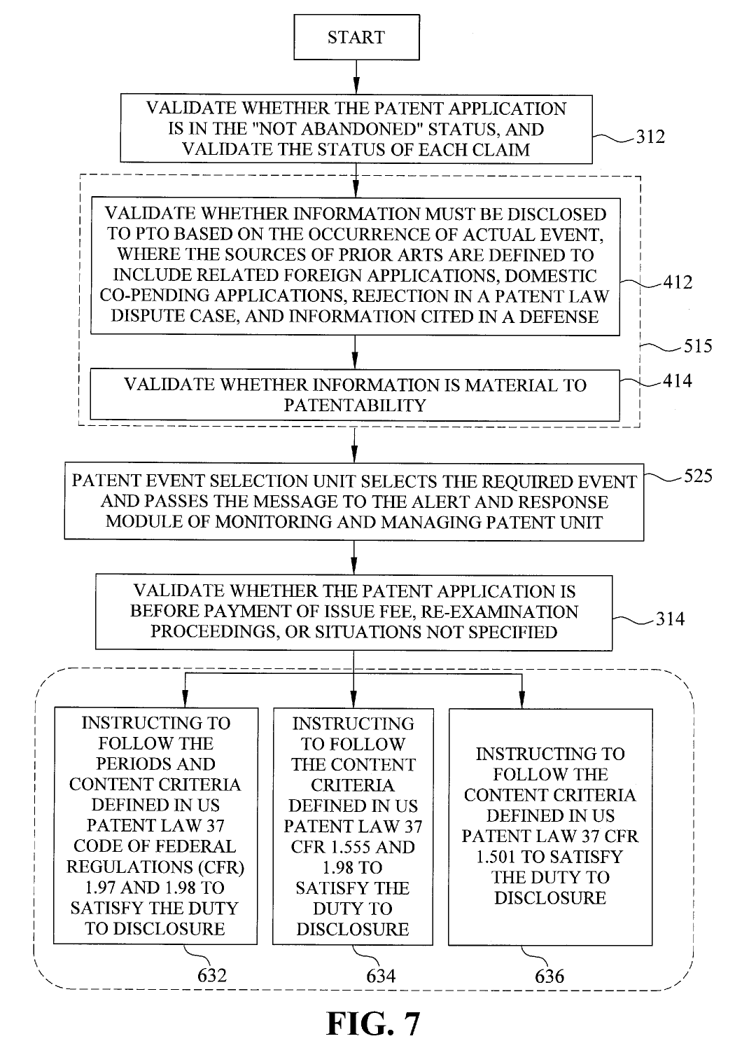

Taking the example of FIG. 5 and using the elements of logic form 630 of suggested course of action 220b in FIG. 6, FIG. 7 shows an exemplary flowchart of using qualification validation module, content validation module and suggested course of action to monitor and control the filing of an information disclosure statement, consistent with certain disclosed exemplary embodiments. Referring to FIG. 7, when passing validation step 312 of qualification validation module 210a, i.e., the patent application is in both “Not Abandoned” status, and each claim is both “Not Withdrawn” and “Nor Cancelled” status, content validation module 210c proceeds to execute the validation in step 515. When passing the validation in step 515, i.e., the information disclosure statement must be filed with PTO and the information is material to patentability, the process proceeds to step 525 for patent event selection unit 110 to select the required event and send message, such as detection signal, to alert and response module 220a for issuing warning output.

After patent event selection unit 110 sends message, such as detection signal, to alert and response module 220a, the validation of qualification validation module 210a of patent event selection unit 110 may be added. That is, qualification validation module may use element 314 of logic form 310 to validate whether the patent application is in before payment of issue fee status, re-examination proceedings status, or after payment of issue fee without re-examination proceedings status. The validation of specific event corresponding to the above three statuses may trigger subsequent suggested course of action 220b to provide three different responses, i.e., responses provided by elements 632, 634, 636 of logic form 630. In this manner, suggested course of action 220b may use a status output, such as processing instruction output, to provide suggested response to user.

Hence, according to the intelligent system for monitoring and managing patent events of the disclosed embodiments, the patent process may be monitored, such as, filing the information disclosure statement. In addition, the general guidelines may also be designed as a plurality of logic forms to be included or embedded in each module of the system. In this manner, based on the content of the logic form, the system may provide user or administrator related suggestions, response or warning messages.

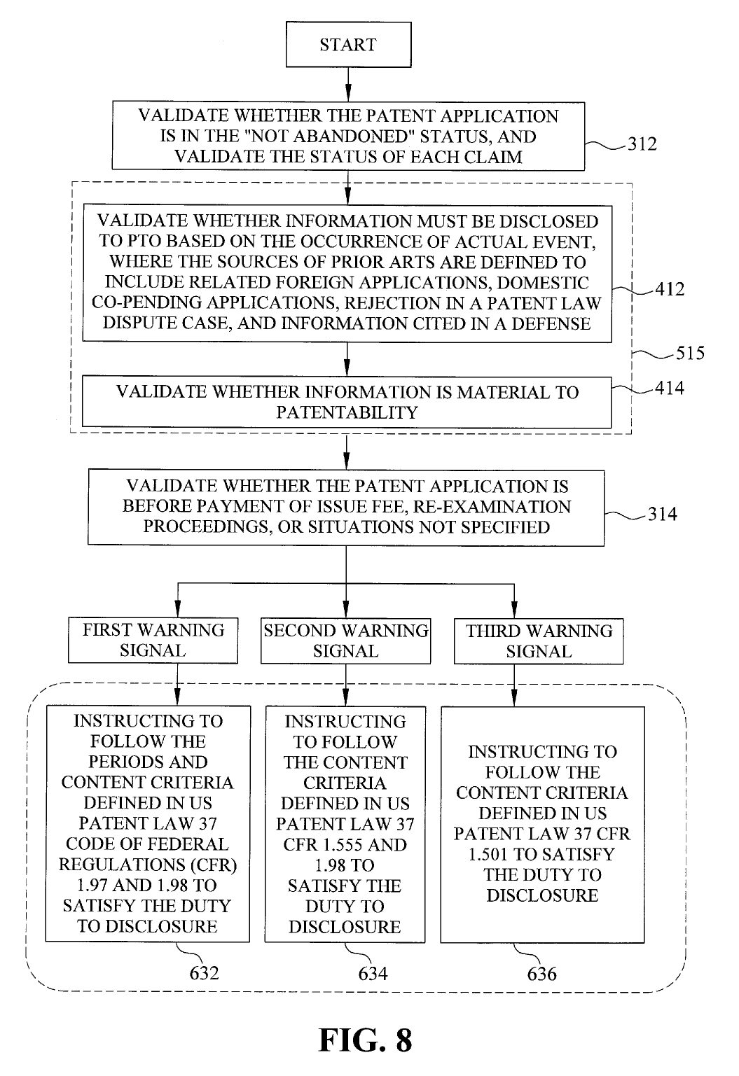

After step 515, besides using patent event selection unit 110 to select required event and sending message, such as detection signal, to alert and response module 220a for issuing status output, such as warning output, another manner may be used to handle monitoring the process of filing an information disclosure statement. FIG. 8 shows another exemplary flowchart of using qualification validation module, content validation module and suggested course of action to monitor and control the filing of an information disclosure statement, consistent with certain disclosed exemplary embodiments. Wherein, qualification validation module 210a of patent event selection unit 110 uses element 314 of logic form 310 to distinguish status output, such as warning output, into three different status outputs, for example, first warning output, second warning output and third warning output.

Accordingly, as shown in FIG. 8, after step 515, patent event selection unit 110 does not need to send the message, such as detection signal, to alert and response module 220a for issuing status output, such as warning output. Instead, element 314 of logic form 310 of qualification validation module 210a may be used directly to validate whether the patent application has the event corresponding to the before payment of issue fee status, re-examination proceedings status or after payment of issue fee without re-examination proceedings status. The validation result by element 314 of logic form 310 only need to output one of the three warning output, i.e., first warning output, second warning output or third warning output, to find the corresponding response of suggested course of action 220b; i.e., the responses provided by elements 632, 634, 636 of logic form 630, respectively.

In the intelligent system for monitoring and managing patent events of the disclosed embodiments, patent event selection unit 110 and monitoring and managing patent unit 120 may also be applied to monitoring the update, such as addition and/or deletion, of inventors. For example, element 316 of logic form 310 of qualification validation module 210a may validate whether the listed inventive entity matches the actual inventors when filing with PTO. Element 318 may validate whether the patent application is non-provisional. Element 322 may validate specific event, such as, whether the initial oath or declaration has been submitted to PTO. After patent event selection unit 110 validates and generate corresponding warnings, monitoring and managing patent unit 120 will generate effective response to the patent event. For example, element 320 of logic form 310 will validate whether a patent certificate has been issued, and generate two types of scenarios, i.e., patent certificate has been issued, and patent certificate has not been issued. Based on the scenario, suggested course of action 220b will design elements 638, 640, 642 of logic form 630 to provide different responses.

Take US Patent Law as example, in the scenario that the patent certificate has been issued, as the patent is granted and issued, elements 638 of logic form 630 may be designed to provide response as: instructing the request for re-issue application or certificate of correction based on the actual discrepancy between the listed inventive entity and the actual invertors. In the scenario that the patent certificate has not been issued, element 322 of logic form 310 must validate whether the initial oath or declaration has been submitted to PTO. If the initial oath or declaration has not been submitted to PTO, element 640 of logic form 630 can be designed to provide response as: instructing to follow US Patent Law CFR1.48(f) to submit the initial oath or declaration to replace the adding or deleting inventors application. If the initial oath or declaration has already been submitted to PTO, element 642 of logic form 630 may be designed to provide response as: instructing, based on the actual discrepancy between the listed inventive entity and the actual inventors, to follow US Patent Law CFR1.48 to submit the adding or deleting inventors application, or to follow US Patent Law CFR1.53(b) to submit continuation application to correct the discrepancy.

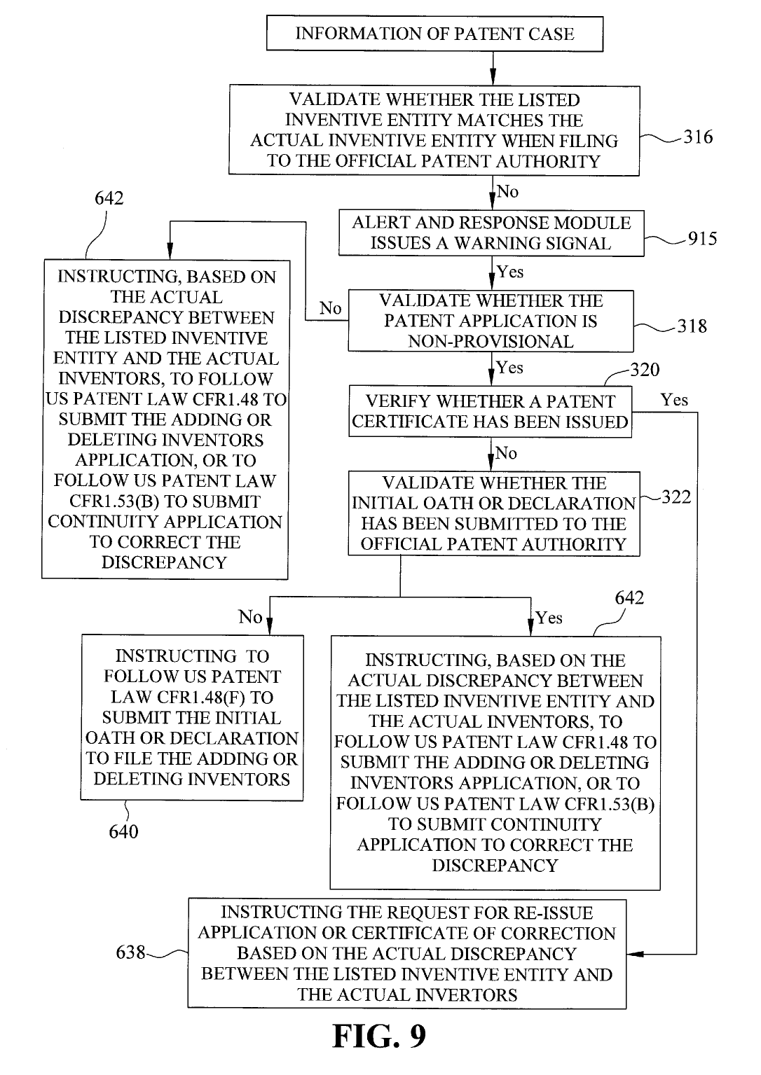

Accordingly, FIG. 9 shows an exemplary flowchart of using patent event selection unit 110 and monitoring and managing patent unit 120 to control the process of adding and deleting inventors, consistent with certain disclosed exemplary embodiments. Referring to FIG. 9, based on the inputted patent information, qualification validation module 210a uses element 316 of logic form 310 to validate whether the listed inventive entity matches the actual inventors completely when filing with PTO; if not, alert and response module 220a issues status output, such as, warning output, as shown in step 915.

After the status output, such as warning output, is issued, element 318 of logic form 310 of qualification validation module 210a validates whether the patent application is non-provisional; if provisional, element 642 of logic form 630 of suggested course of action 220b will provide the response as aforementioned. If non-provisional, element 320 of logic form 310 of qualification validation module 210a further validates whether the patent certificate has been issued. If issued, element 638 of logic form 630 of suggested course of action 220b will provide response as aforementioned. If not yet issued, element 322 of logic form 310 of qualification validation module 210a further validates whether initial oath or declaration has been submitted. If so, element 640 of logic form 630 of suggested course of action 220a will provide response as aforementioned. If the initial oath or declaration has yet been submitted, element 642 of logic form 630 of suggested course of action 220a will provide response as aforementioned.

Therefore, adding and/or deleting inventor and the monitoring of filing the information disclosure statement may both be accomplished by presetting the triggering conditions and corresponding status according to the monitoring and analysis result, such as detection signal, of the patent document, and generating corresponding status output, such as, warning response or providing suggested course of action. The presetting triggering condition and corresponding status may be designed as a plurality of logic forms, or included or embedded in each module of the intelligent system for monitoring and managing patent events of the present invention. Based on the logic form content, suggested actions or warning messages can also be provided to the user or the administrator.

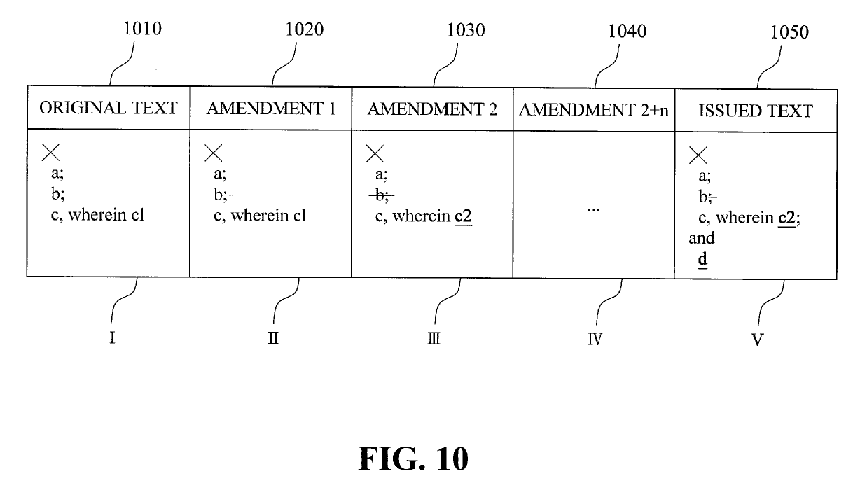

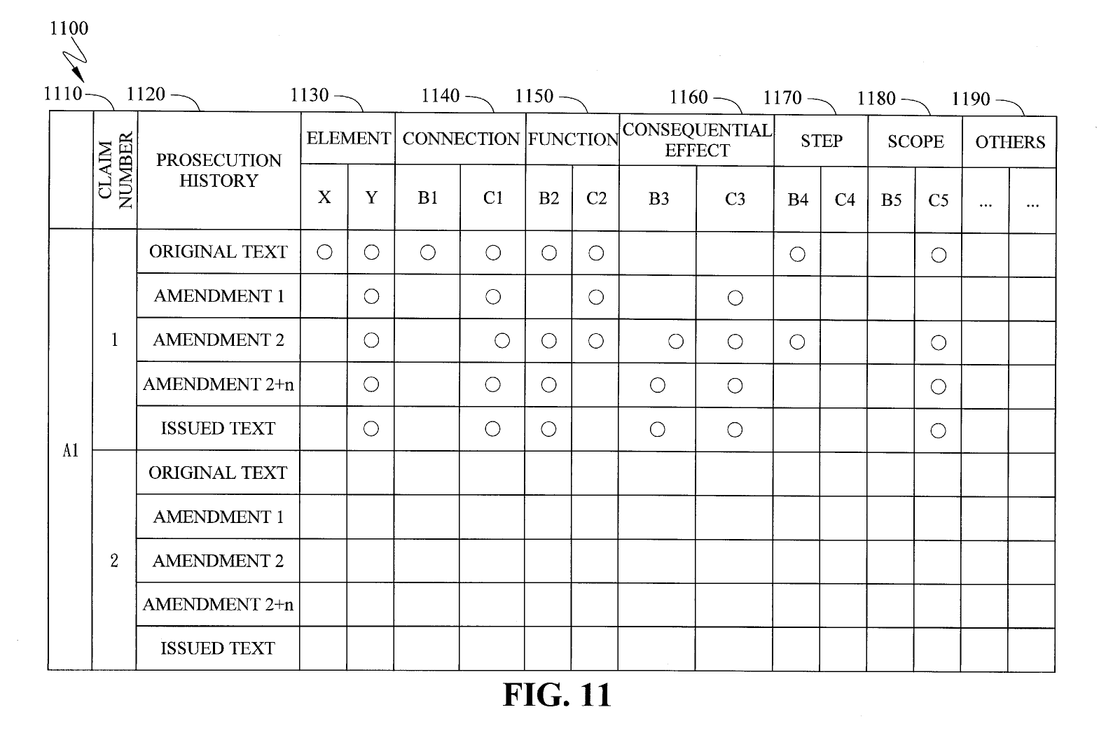

Revisit the design of element 416 of logic form 410 of content validation module 210c. Element 416 is designed to validate whether any addition or deletion of claims in the prosecution history has occurred. If so, the result of the logic predicate of element 416 is to pass. In addition to generating the “pass” result, a form may be also generated. The form may display the change history of the claims from filing to final allowance. Also, the attributes of the claims after the analysis of content validation module 210c may be displayed along the changes of the claims. FIG. 10 and FIG. 11 show two exemplary forms generated by the analysis of content validation module 210c, consistent with certain disclosed exemplary embodiments.

The exemplary form in FIG. 10 shows the change history of the claims from filing to the final allowance. Because a claim may change more than once during the entire prosecution history, the form in FIG. 10 includes a field, such as, first field 1010, using original text as the comparison basis. This field 1010 records the original text of the claim when filing. After validated by element 416 of logic form 410 to have changed, the change is reflected in amendment 1 of second field 1020 for the deleted text and in amendment 2 of third field 1030 for the inserted text. In addition, the previous change may be designed to either visible or invisible (e.g., the deleted text of element b can be set to be either visible or invisible in field 1030). In field 1030, the claim of original element C changes from C1 to C2. One way to depict the change is to delete C1 and display C2 underlined, as shown in current 1030, or display C1 crossed-out and C2 underlined side by side. The crossed-out or underlined text is for differentiating “deleted” and/or “inserted”, or the modified claims. Other similar approaches to depict the changes are also within the scope of the present invention. In this manner, from amendment 1 1020 to amendment 2+n 1040, each change of claim can be depicted in the form until the issued text of the claims reflected in field 1050. If the claim is changed more than once, the system of the disclosed may be designed to display all the previous changes in each field, or only the most recent change, such as the change between (2+n) and (2+n−1). The typical embodiment is to input a US patent prosecution history PDF document, analyze the text content with OCR manner, and extract the history of paragraph of changed claims. In the above manner, the form in FIG. 10 is obtained.

The exemplary form in FIG. 11 is another way to display the claim changes, called graphic interface (UI). The original text or the prosecution history by content validation module. If the data source is in PDF format, the current approach is to use OCR to translate into a text file format. Then, semantic analysis technology, artificial intelligence technology and/or form lookup are applied to extract the attributes of the claims, such as an attribute information. The exemplary form in FIG. 11 shows the attributes of the claims, including element attribute 1130, connection attribute 1140, function attribute 1150, consequential effect attribute 1160, step attribute 1170, scope attribute 1180 and others attribute 1190. The seven attributes may be represented, but not limited to, by element attribute information (element attribute 1130), connection attribute information (connection attribute 1140), function attribute information (function attribute 1150), consequential effect attribute information (consequential effect attribute 1160), step attribute information (step attribute 1170), scope attribute information(scope attribute 1180) and others attribute information (e.g. others attribute 1190). Here, the attributes of the claims have been described with reference to the exemplar of FIG. 11, it will be understood that the invention is not limited to the details described thereof.

Element attribute 1130 is to mark the text in the claim having the characteristics of constructing part, or called the constructing basic factors (such as, element, device, component, module, and so on.) Connection attribute 1140 is to mark the text in the claim having the spatial and structural relative relation (such as, in the factors of 1130, the relative spatial relation between X element and Y element). The function attribute 1150 is to mark the text in the claim describing the functions. The consequential effect attribute 1160 is to mark the text in the claim indicating the consequential effects of the aforementioned disclosure. Step attribute 1170 is to mark the text in the claim describing the operation or status in a process. Scope attribute 1180 is to mark the text in the claim describing a fixed measurement or range of value. Based n the analysis and attribute classification, the user can define the others attribute 1190.

The claim number of the original application document is marked in field 1110. The claims of the original application document may be classified according to the above attributes, and reflected in the claim changes of the original text history recorded in field 1120 corresponding to a single claim number. Each patent application, such as, A1, based on the claim changes, each changed text is recorded, after analysis of attributes by content validation module 210c, in the row of a specific claim number and specific number of change, and a label is marked to the corresponding attribute field (e.g., mark “◯” FIG. 11). Basically, the issued text in the certificate will also be analyzed for attributes. The summary analysis will generate an exemplary form 1100 of FIG. 11 to provide the inventor, researcher or patent attorney for legal battle preparation. In this manner, form 1100 is not a simple information disclosure, but a functional data able to provide the above functions instead.

On certain occasions, the defender of the case in dispute may delete some or all claims and append to the rewritten claims to the end and re-enumerate. In another embodiment, the setting, semantic analysis technology, artificial intelligence technology and form lookup technology may also be used to view the similar part of the claims as a claim number 1110 of the same claim. The main objective is to use the system to summarize the possible directions of restriction or estoppel incurred during the amendment process so that the user may get a rough picture before review the document in detail. Other similar system implementing this objective is also within the scope of the present invention.

Hence, the intelligent system for monitoring and managing patent events of the disclosed may systemically monitor and control the patent application process to ensure that each application step follows the regulation as well as to reduce the labor and operation cost of managing patents. When facing a patent allegation with a plurality of patents as infringed targets, the systematic monitoring and controlling of the process may be used to analyze the claims change, final issued text and abandoned claims of the infringed patents. Or, further analysis to find whether any invalid or unenforceable evidence exists can be used as legal action strategy to save the law suit cost.

Accordingly, the method for monitoring and managing patent events of the disclosed may be described in the following embodiments.

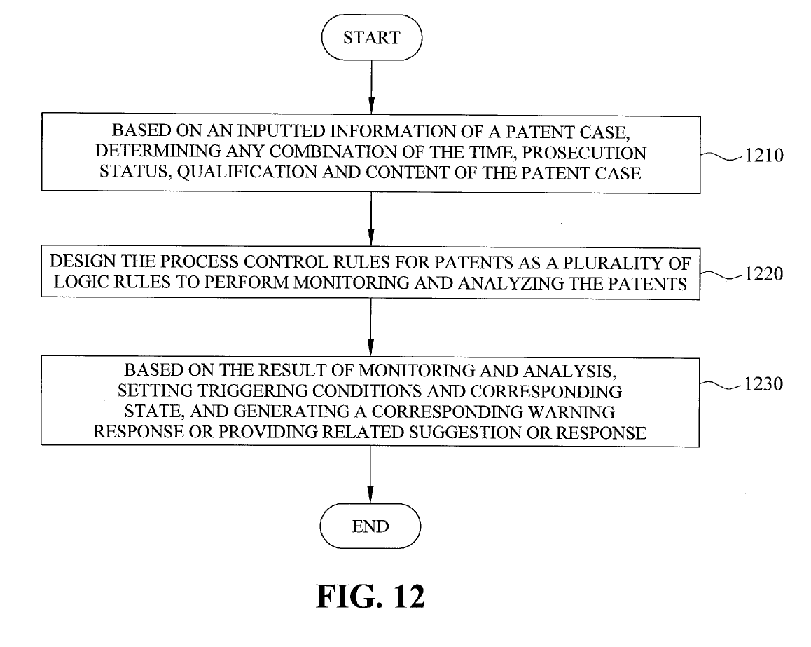

FIG. 12 shows an exemplary schematic view of an intelligent method for monitoring and managing patent events, consistent with certain disclosed exemplary embodiments. In the exemplary embodiment of FIG. 12, step 1210 is, based on an inputted information of a patent (either a single or a plurality of patent number), determining any combination of the time, prosecution status, qualification and content of the patent. Step 1220 is to design the process control rules for patents as a plurality of logic rules to perform monitoring and analyzing the patent. Step 1230 is, based on the result of monitoring and analysis, setting triggering conditions (or use the system's presetting) and corresponding state (or system's preset corresponding state), and generating corresponding warning response or providing related suggestion or response.

In step 1220, a plurality of logic rules may be designed as the embodiments of FIG. 3 and FIG. 4, and the description is omitted here. The exemplary actual applications of process control for patent applications is shown in FIG. 6, the exemplary control of filing information disclosure statement is shown in FIG. 8, and the exemplary control on addition and/or deletion of inventors is shown in FIG. 9, thus the description is omitted here.

In step 1230, the setting triggering conditions and corresponding state, and generating a corresponding warning response are as shown in the contents of the elements of logic forms 310, 410, thus the description is omitted here. The providing related suggestion or response may be embodied as the contents of the elements of logic form 630, thus is omitted here.

The intelligent system for monitoring and managing patent events of the disclosed may further provide an operation interface so that the attorney may use the operation interface to execute the legal work confirmation so that the form or the data of the analysis may be used as evidence for seeking legal advice or aids for legal battle. The main objective of the operation interface is to allow the authorized personnel to login with specific account, execute auditing on the data or result, and conduct confirmation exchange or related interaction so that the analysis or result may stay confidential and protected by the attorney-client privilege.

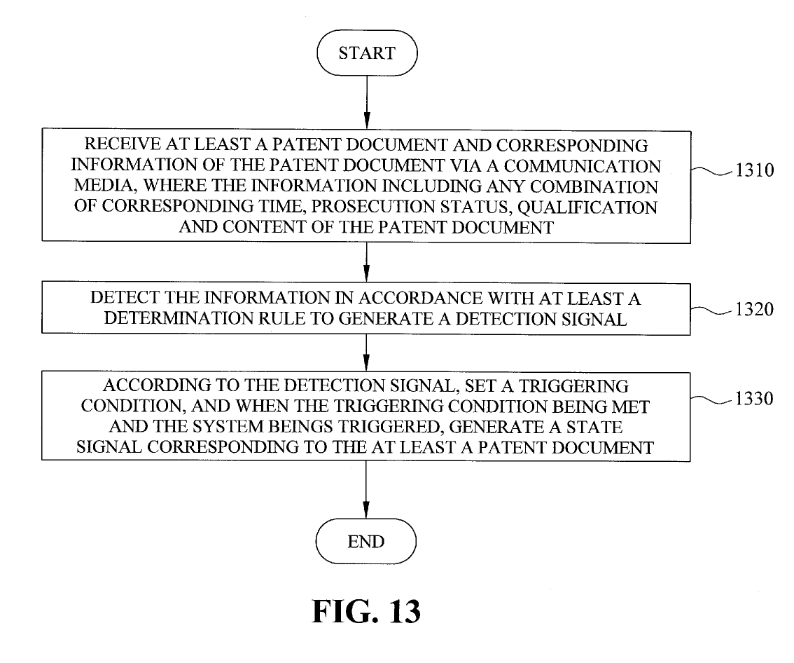

FIG. 13 shows another exemplary schematic view of an intelligent method for monitoring and managing patent events, which is applied to an information processing device and displays the patent analysis result in a graphic manner, consistent with certain disclosed exemplary embodiments. The method is applicable to an information processing device, and displays the patent analysis result in a graphic manner. In the exemplary method shown in FIG. 13, step 1310 is to use a communication media to receive at least a patent document and corresponding information of the patent document, where the information including any combination of corresponding time, prosecution status, qualification and content of the patent document. Step 1320 is to detect the information in accordance with at least a determination rule to generate a detection signal. Step 1330 is, according to the detection signal, to set a triggering condition, and when the triggering condition being met and the system beings triggered, to generate a state signal corresponding to the at least a patent document.

In step 1320, the at least a determination rule may be any combination of at least a patent document process control rule, at least a time determination rule, at least a qualification determination rule, at least a content determination rule, and at least a figure determination rule. The detection signal may be any combination of a time detection signal, a qualification detection signal, a content detection signal, and a figure detection signal. The time detection signal, the qualification detection signal and the figure detection signal are to represent the corresponding relevance of at least a patent document. In step 1330, the status signal may be any combination of a warning signal and a handling instruction signal.

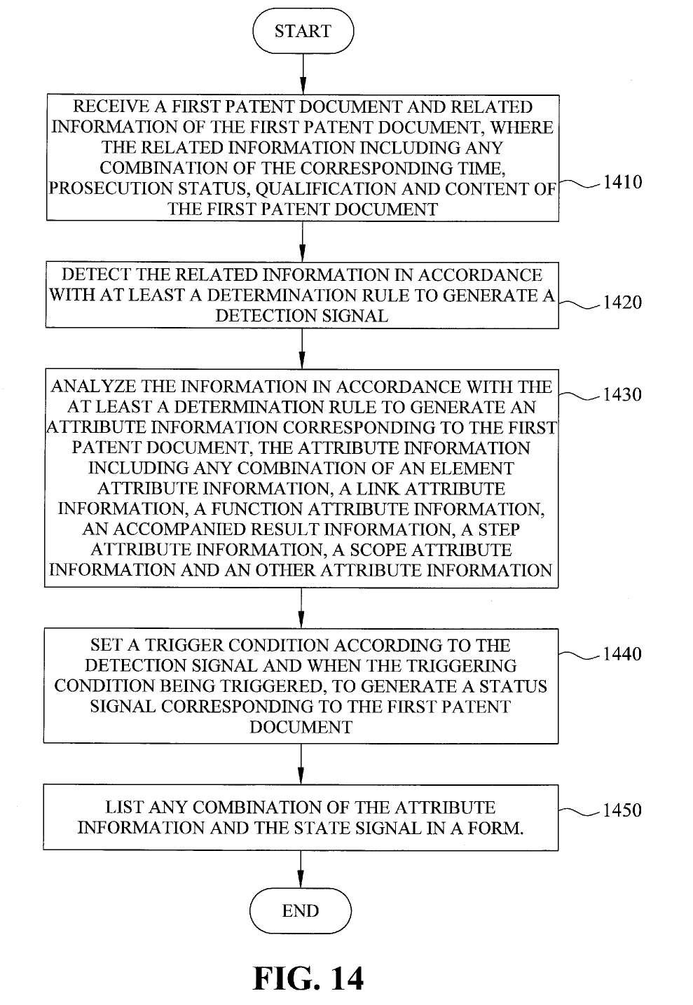

FIG. 14 shows another exemplary schematic view of an intelligent method for monitoring and managing patent events, applicable to an information processing device, consistent with certain disclosed exemplary embodiments. The method is applicable to an information processing device. In the exemplary method of FIG. 14, step 1410 is to receive a first patent document and related information of the first patent document, where the related information including any combination of the corresponding time, prosecution status, qualification and content of the first patent document. Step 1420 is to detect the related information in accordance with at least a determination rule to generate a detection signal. Step 1430 is to analyze the information in accordance with the at least a determination rule to generate an attribute information corresponding to the first patent document, the attribute information including any combination of an element attribute information, a link attribute information, a function attribute information, an accompanied result information, a step attribute information, a scope attribute information and an others attribute information. Step 1440 is to set a trigger condition according to the detection signal and when the triggering condition being triggered, to generate a status signal corresponding to the first patent document. Step 1450 is to list any combination of the attribute information and the state signal in a form. For example, the form may include the complete prosecution history of the claims of the first patent document, and uses figure (as shown in FIG. 11) as the attribute information.

In step 1420, the generation of the detection signal may further include the following steps of: receiving a second patent document and related information of the second patent document, where the related information including any combination of the corresponding time, prosecution status, qualification and content of the second patent document; detecting the related information in accordance with at least a determination rule to generate a second detection signal corresponding to the second patent document; for example, the second detection signal may be as the aforementioned detection signal corresponding to the first patent document, further including any combination of a second time detection signal, a second qualification detection signal, a second content detection signal and a second figure detection signal; comparing the first detection signal and the second detection signal, and determining a weight according to the similarity of the first detection signal and the second detection signal; for example, comparing the first qualification signal and the second qualification detection signal, and determining a qualification weight according to the similarity between the first qualification detection signal and the second qualification detection signal; and determining a relevance between the first patent document and the second patent document according to the weight; for example, determining a qualification relevance between the first patent document and the second patent document according to the qualification weight. Similarly, the determination of weight and relevance may also be performed targeting time detection signal, content detection signal and figure detection signal, thus the description is omitted here.

Yet in another exemplary embodiment, the disclosed may provide a method of identifying relevant patent documents for an information processing device. The method comprises: extracting a first data of a first patent document; extracting a second data of a second patent document; and when the first data and the second data satisfying a pre-defined condition of the information processing device, marking the first patent document and the second patent document as relevant patents.

In another exemplary embodiment, the disclosed may provide a method of identifying relevant patent documents for an information processing device. The method comprises: comparing a first data corresponding to a first patent document to a second data corresponding to a second patent document; and when the comparison result matching a pre-defined condition of the information processing device, marking the first patent document and the second patent document as relevant patents.

Yet in another exemplary embodiment, the disclosed may provide a method of identifying relevant patent documents for an information processing device. The method comprises: extracting at least a first characteristic data of a first patent document; extracting at least a second characteristic data of a second patent document; comparing the first characteristic data and the second characteristic data to generate a corresponding relevance. The relevance may be induced from the weighting mechanism of the aforementioned system.

Yet in another exemplary embodiment, the disclosed may provide a method of displaying relevant attributes of a patent document for an information processing device. The method comprises: establishing an actual graphical interface in a two-dimensional array; marking a version of a target claim of a patent document and displaying in the first dimension of the graphical interface; and listing and displaying the content of status of at least an attribute information of the target claim in each version in the second dimension of the graphical interface.

Yet in another exemplary embodiment, the disclosed may provide a method of displaying relevant attributes of a patent document for an information processing device. The method comprises: establishing an actual graphical interface in a two-dimensional array; marking the status or content of an attribute information of a target claim of a patent document in each historical version of the target claim, and displaying in the first dimension of the graphical interface; and listing and displaying a plurality of attribute information of the target claim in a target version in the second dimension of the graphical interface.

In summary, the aforementioned disclosure is to use an information processing device (such as, a computer, PDA or cell phone) to execute a technical data processing program (such as, patent event selection unit 110 and monitoring and managing patent unit 120) to process the external technical data (such as, patent document) extracted externally or internal technical data obtained internally into a functional data (such as, form 1100) able to provide the use with the above functions. Also, the present invention may enable the user to interact with the device because of the functional data (such as, according to the corresponding suggestion or handling action to input the objective that the user aims to achieve). In addition, the present invention may also be used to improve the search, comparison, summary, monitor and control of the patent documents, and time and cost of the patent legal allegation. Furthermore, the graphic interface if FIG. 11 may reduce the consumption of the system resource of opening and closing files to improve the system performance as well as a friendly and convenient interface.

In another exemplary embodiment, the disclosed may provide a computer program product applicable to hardware, and the computer program product may be program code written to implement the functions and/or steps of the disclosed method and is stored in a storage medium, such as, memory. By executing the program code on the hardware, an intelligent method for monitoring and managing patents of the disclosed method may be realized. The hardware may be, but not limited to, a computer, a device able to execute multiple threads, a device able to execute a single thread.

In another exemplary embodiment, a user may use Internet-enabled device, such as, computer, mobile phone or PDA, to login to a server. The server may be installed with the system and/or software of the present invention, and the user may execute directly the operation of the disclosed intelligent method for monitoring and managing patents on the server. Alternatively, the user may use an internet-enabled device, such as, computer, mobile phone or PDA, to login to a server. Through the server and the database system installed with the system and/or method of the present invention to execute the operations of the disclosed intelligent method for monitoring and managing patents.

Although the present invention has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A system for monitoring and managing patent events, comprising:
a patent event selection unit, for verifying any combination of time, prosecution status, qualification and contents of a patent according to inputted information related to said patent, as well as monitoring and analyzing said patent; and
a monitoring and managing patent unit, for setting up triggering condition and corresponding status, and generating a corresponding response or providing a related suggestion or a handling manner according to at least a result from said monitoring and analyzing said patent.

2. The system as claimed in claim 1, wherein said patent event selection unit further includes any combination of a qualification validation module, a time validation module, a content validation module, a figure validation module and an interactive matching validation module; and before monitoring and analyzing said patent, decomposing said patent, and assigning, based on type and definition, to any combination of said qualification validation module, said time validation module, said content validation module, said figure validation module and said interactive matching validation module for analysis.

3. The system as claimed in claim 2, wherein said monitoring and managing patent event further includes any combination of an alert and response module and a suggested course of action, and based on analysis result of each said module of said patent event selection unit, when pre-set triggering conditions being met, sending a pre-set corresponding response instruction to any combination of said alert and response module and said suggested course of action.

4. The system as claimed in claim 1, said system generates a first form, and said first form displays changes of at least a claim of said patent from filing to final allowance.

5. The system as claimed in claim 4, said system generates a second form, and said second form displays changes of at least an attribute of claim content after analyzing said first form.

6. The system as claimed in claim 5, wherein said at least an attribute further includes any combination of element attribute, connection attribute, function attribute, consequential effect attribute, step attribute, scope attribute, and others attribute.

7. A system for monitoring and managing patent events, comprising:
a patent event selection unit, for receiving information of at least a patent document, and detecting said information of said at least a patent document in accordance with at least a determination rule to generate a detection signal; and
a monitoring patent unit, for setting up triggering conditions according to said detection signal, and when said triggering condition being met and said system being triggered, generating a status signal corresponding to said at least a document;
wherein said information of said at least a patent document further includes any combination of time, prosecution status, qualification and contents of said patent document, said detection signal comprising any combination of a time detection signal, a qualification detection signal, a content detection signal and a figure detection signal, said time detection signal, said qualification detection signal, said content detection signal and said figure detection signal being used to represent respectively a time relevance, a qualification relevance, a content relevance and a figure relevance of said at least a document in terms of time, qualification, content and figure.

8. The system as claimed in claim 7, wherein said patent event selection unit further comprises:
a time validation module, for receiving information of said at least a patent document, and based on at least a time determination rule to detect time corresponding to said at least a patent document to generate said time detection signal corresponding to said at least a patent document, wherein said time detection signal further includes any combination of an application date status, a key date status, an issue date for rejection notice status, an issue date for allowance notice status, a fee payment date status, a publication date status, and an issue date status.

9. The system as claimed in claim 7, wherein patent event selection unit further includes:
a qualification validation module, for receiving information of said at least a patent document, and based on at least a qualification determination rule to detect qualification corresponding to said at least a patent document to generate said qualification detection signal corresponding to said at least a patent document, wherein said qualification detection signal further includes any combination of an inventor status, an assignee status, a patent prosecution status and a claim status.

10. The system as claimed in claim 7, wherein said patent event selection unit further includes:
a content validation module, for receiving information of said at least a patent document, and based on at least a content determination rule to detect content corresponding to said at least a patent document to generate said content detection signal corresponding to said at least a patent document, wherein said content detection signal further includes any combination of a prior art reference information, a claim content information, and a claim change status.

11. The system as claimed in claim 10, wherein said claim content information further includes claim attribute information, and said claim attribute information further includes:
any combination of an element attribute information, a connection attribute information, a function attribute information, a consequential effect attribute information, a step attribute information, a scope attribute information and an others attribute information.

12. The system as claimed in claim 7, wherein patent event selection unit further includes:
a figure validation module, for receiving information of said at least a patent document, and based on at least a figure determination rule to detect at least a figure corresponding to said at least a patent document to generate said figure detection signal corresponding to said at least a patent document.

13. The system as claimed in claim 7, wherein patent event selection unit further includes:
an interactive matching validation module, for performing relevance analysis on any two of said time relevance, said qualification relevance, said content relevance and said figure relevance, and generating relevance information corresponding to said relevance analysis.

14. The system as claimed in claim 7, wherein said patent event selection unit, before monitoring and analyzing said patent document, decomposes said patent document and assigns, and based on type and definition, assigns said decomposed patent document to any combination of a qualification validation module, a time validation module, a content validation module and a figure validation module for further processing.

15. The system as claimed in claim 14, wherein said patent event selection unit further includes:
an interactive matching validation module, for performing relevance analysis on any two of said time relevance, said qualification relevance, said content relevance and said figure relevance, and generating relevance information corresponding to said relevance analysis.

16. The system as claimed in claim 7, wherein said monitoring and managing patent unit further includes:
an alert and response module, for receiving said detection signal and setting triggering conditions of said system based on said detection signal, when said at least a triggering condition of said system being met, generating a warning signal corresponding to said at least a patent document; and
a suggested course of action, for generating a handling instruction signal based on said warning signal.

17. A method for an information processing device displaying related attributes of a patent document, comprising:
establishing an actual graphical interface in a two-dimensional array;
marking a version of a target claim of a patent document and displaying in a first dimension of said graphical interface; and
listing and displaying content of status of at least an attribute information of said target claim in each version in a second dimension of said graphical interface.

18. A method for an information processing device displaying related attributes of a patent document, comprising:
establishing an actual graphical interface in a two-dimensional array;
marking status or content of an attribute information of a target claim of a patent document in each historical version of said target claim, and displaying in a first dimension of said graphical interface; and
listing and displaying a plurality of attribute information of said target claim in a target version in a second dimension of said graphical interface.
